(19) United States
(12) Patent Application Publication
(10) Pub. No.: US 2025/0136444 A1
(43) Pub. Date: May 1, 2025

(54) HYDROGEN PRODUCTION PROCESS WITH CARBON DIOXIDE CAPTURE HAVING REDUCED CARBON INTENSITY

(71) Applicant: UOP LLC, Des Plaines, IL (US)

(72) Inventors: Michael R. Van de Cotte, Palatine, IL (US); Lin Jin, Inverness, IL (US); Bradley Russell, Fall Branch, TN (US)

(21) Appl. No.: 18/741,973

(22) Filed: Jun. 13, 2024

Related U.S. Application Data
(60) Provisional application No. 63/594,333, filed on Oct. 30, 2023.

(51) Int. Cl. C01B 3/50; B01D 53/00; C01B 3/56; C01B 32/50; F01K 15/00

(52) U.S. Cl. CPC C01B 3/506; B01D 53/002; C01B 3/56; C01B 32/50; F01K 15/00; B01D 2256/16; B01D 2257/504; C01B 2203/046; C01B 2203/0475; C01B 2203/86; F25J 2230/22

(57) ABSTRACT

Methods which utilize low-grade heat produced in the hydrogen production process to reduce the energy required by the compressor to compress the PSA tail gas stream. The low-grade heat is used to produce a low-pressure steam stream. The low pressure steam stream is introduced to a steam turbine to generate power. The power produced by the turbine reduces the amount of power required to operate the tail gas compressor, thus reducing the overall power requirement for the process.

### RELATED APPLICATIONS

This application claims priority to U.S. Provisional Patent Application Ser. No. 63/594,333, filed on Oct. 30, 2023, the entirety of which is incorporated herein by reference.

### BACKGROUND

Hydrogen is expected to have significant growth potential because it is a clean-burning fuel. However, hydrogen production is traditionally a significant emitter of CO₂, and government regulations and societal pressures are increasingly taxing or penalizing CO₂ emissions or incentivizing CO₂ capture. Consequently, significant competition to lower the cost of hydrogen production while recovering the byproduct CO₂ for subsequent geological sequestration to capture the growing market is anticipated. CO₂ can be separated as a vapor to be supplied to a common pipeline, but more likely it will need to be produced in liquefied form for easy transport by truck or ship due to the current lack of CO₂ pipeline infrastructure in certain areas of the world.

The desired level of CO₂ emissions mitigated will depend on regional economic conditions, with some hydrogen producers prioritizing maximizing hydrogen production with CO₂ capture, others prioritizing minimal CO₂ emissions with hydrogen production, and some falling somewhere in-between. Another important factor is the reformer technology chosen for a given hydrogen production unit. For steam reforming plants, 50% to 60% CO₂ capture may be sufficient, while greater than 90% or greater than 95% may be expected for an autothermal reformer (ATR), gasifier, or partial oxidation (POX) reformer.

Most existing hydrogen production processes utilize pressure swing adsorption (PSA) to recover high-purity product hydrogen from shifted syngas. For example, U.S. Pat. No. 8,021,464 describes one example of an existing processes for the combined production of hydrogen and CO₂ from a mixture of hydrocarbons which are converted to syngas. The syngas is separated in a pressure swing adsorption (PSA) unit into a hydrogen-enriched stream and a PSA offgas stream. The PSA offgas is compressed and dried, followed by several successive steps of condensing and separating the CO₂-rich condensate with the temperature being reduced at each step.

Reducing the amount of energy needed to operate the process would improve the overall economics of the process. Because the dominant energy user in this type of process is the compressor for the PSA offgas stream, it would be desirable to decrease the amount of energy required for the offgas compressor.

Therefore, there is a need for improved hydrogen production processes with lower energy requirements.

### BRIEF DESCRIPTION OF THE DRAWINGS

FIG. 1 is an illustration of one embodiment of a method of producing hydrogen and recovering CO₂ from a hydrogen production process according to the present invention.

FIG. 2 is an illustration of one embodiment of a condensing steam turbine useful in the present invention.

FIG. 3 is an illustration of another embodiment of a condensing steam turbine useful in the present invention.

### DESCRIPTION

The present invention meets this need by providing a method which utilizes low-grade heat produced in the hydrogen production process to reduce the energy required by the compressor to compress the PSA tail gas stream (or any other compressor, such as a refrigerant gas compressor in a cryogenic CO₂ fractionation process). The low-grade heat is used to produce a low-pressure steam stream. The low pressure steam stream is introduced to a steam turbine to generate power. The power produced by the turbine reduces the amount of power required to operate the tail gas compressor (or any other compressor, such as a refrigerant gas compressor in a cryogenic CO₂ fractionation process), thus reducing the overall power requirement for the process.

Low-grade heat from the hydrogen production process can be used to generate low-pressure steam which is then used to directly produce shaft work to drive an electric motor driven tail gas compression train or other gas compression train, such as the refrigerant gas compressor. Alternatively, a dedicated steam turbine generator could be used. Low-grade heat can be recovered from the syngas cooling train downstream of the water-gas shift reactor in a hydrogen production process. Low-grade heat corresponds to temperatures less than about 250° C. Low-pressure steam comprises saturated or superheated steam with pressures less than about 700 kPa(g).

The waste heat from the hydrogen production process is used to superheat one or more waste steam stream. The superheat conditions are established to ensure the mechanical integrity of the steam turbine is not compromised. It is desirable to use the minimum amount of superheat to minimize the amount of energy input to improve the quality of the steam such that the minimum requirement for the steam turbine (moisture level in the steam turbine exhaust. This is assessed by quantifying the % moisture at the steam turbine exhaust. A steam turbine driver is added to convert the superheated waste steam stream into shaft work. The steam turbine, such as a condensing-induction steam turbine, has a suction nozzle(s) to intake the low pressure waste steam streams. The steam from the condensing-induction steam turbine is exhausted to a steam surface condenser, which may be water cooled, air cooled, or wetted surface air cooled. The steam turbine can be connected directly to the PSA tail gas compression train or other compression train such as the refrigerant gas compressor in the cryogenic CO₂ fractionation process. This results in a compression train with an electric motor and the steam turbine. Specific compression train controls and protections known to those of skill in the art are used to achieve these benefits. Directly connecting to the PSA tail gas compressor maximizes the total energy which can be recovered. Alternatively, a simple steam turbine generator set could be used. However, it would only capture 85-90% of the available energy and would do so with higher capital costs due to additional mechanical and electrical components such as, but not limited to, speed changing gearbox, generator, electrical switchgear, transformers, etc.

The hydrogen production process includes a synthesis gas production zone that produces synthesis gas. The synthesis gas production zone may comprise a new or existing synthesis gas reactor, including, but not limited to, a steam reforming unit with an optional gas heated reformer, an autothermal reforming unit with an optional gas heated reformer, a gasification unit, or a partial oxidation (POX) unit, or combinations thereof.

The synthesis gas reactor produces an effluent which comprises a mixture of gases comprising hydrogen, carbon dioxide, water, and at least one of methane, carbon monoxide, nitrogen, and argon.

The synthesis gas reactor is typically followed by a water gas shift (WGS) unit to convert carbon monoxide to carbon dioxide. The effluent stream exiting the WGS unit is typically about 220° C. to 420° C.

Heat is recovered from WGS effluent stream (e.g., to produce steam) and then the effluent stream is typically further cooled using an air or water cooler to a temperature of about 35° C. to 60° C. The temperature is limited by the temperature of the air or water used in the cooler.

The cooled synthesis gas stream is sent to a hydrogen pressure swing adsorption (PSA) unit for separation into a high-pressure hydrogen stream enriched in hydrogen and a hydrogen depleted tail gas stream comprising the remaining hydrogen, carbon dioxide, water, and the at least one of the methane, carbon monoxide, nitrogen, and argon. The high-pressure hydrogen stream typically contains about 85% to 90% of the hydrogen in the effluent, which is recovered.

The hydrogen depleted tail gas stream is compressed in the tail gas compressor. A low-pressure steam stream from the synthesis gas production zone is sent to a steam turbine to generate energy. The energy produced by the steam turbine is used to operate the tail gas compressor, reducing the amount of energy required from other sources.

The compressed tail gas stream is dried and sent to a CO₂ recovery system where it is separated into a CO₂-enriched product stream and an overhead stream comprising the hydrogen, and some carbon dioxide, and some of the at least one of the methane, carbon monoxide, nitrogen, and argon.

The overhead stream is sent to a second PSA unit that produces a low-pressure CO₂ stream enriched in carbon dioxide and an off-gas stream enriched in hydrogen and at least one of carbon monoxide, methane, nitrogen, and argon.

The off-gas stream may be sent to a third PSA unit for separation into an additional purified high-pressure hydrogen product stream and a low pressure tail gas stream, which can be combusted as fuel, recycled to the synthesis gas production unit, or both. Alternatively, the off-gas stream can be sent to a gas turbine or co-generation system for generation of electric power and steam. When gas turbine or co-generation system is present, the exhaust heat from this equipment may be used as source of heat energy to upgrade the quality of the low grade heat steam; i.e. create the target superheat. Another possibility is sending the off-gas stream to a membrane separation unit with the permeate being enriched in hydrogen which can be used as a clean fuel product and the residue recycled to the synthesis gas production unit.

The low-pressure CO₂ stream may be combined with the low-pressure tail gas stream from the hydrogen PSA unit and sent to the tail gas compressor.

The CO₂ recovery unit may comprise an amine separation unit with a CO₂ chiller and liquefier, or a cryogenic fractionation unit, or a carbon dioxide PSA unit with a CO₂ chiller and liquefier, or combinations thereof. Chilling duty for these different types of CO₂ recovery units is generally provided by a mechanical refrigeration system using a suitable refrigerant and a vapor compression cycle. In some cases, a mixed refrigerant may be used in order to minimize compression power. For example, a three-component mixed refrigerant comprising propane, iso-pentane, and carbon dioxide can be used. The power recovered from the low-grade heat may also be used to reduce the power consumption of the refrigerant gas compressor.

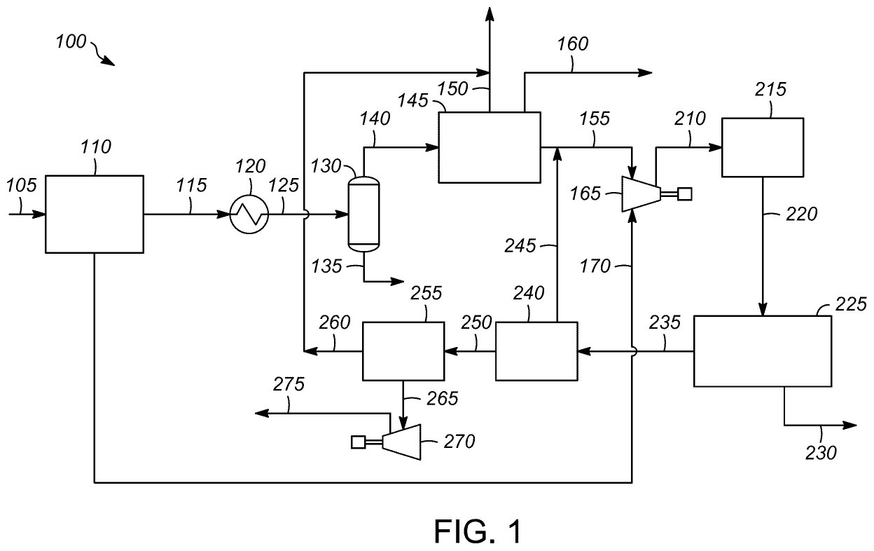

FIG. 1 illustrates one embodiment of process 100 for producing a high-pressure hydrogen product stream enriched in hydrogen and a carbon dioxide-enriched product stream. The feed stream 105 is introduced into the hydrogen production process unit 110 where it is converted into synthesis gas. The synthesis gas mixture comprises hydrogen, carbon monoxide, carbon dioxide, methane, water, and inert gas. The synthesis gas mixture is sent to a water gas shift reactor in the hydrogen production process unit 110 to convert carbon monoxide to carbon dioxide.

The shifted synthesis gas stream 115 may have a temperature of 35° C. to 60° C., and a pressure of about 2000 kPa(g) to about 4000 kPa(g). The shifted synthesis gas may contain 70 to 80 mol % hydrogen, 15 to 25 mol % carbon dioxide, 1 to 4 mol % methane, 0.5 to 3 mol % carbon monoxide, 0 to 0.5 mol % nitrogen, 0.2 to 0.6 mol % water (saturated), 0 to 0.2 mol % argon, and 0 to 500 ppmv methanol.

The shifted synthesis gas stream 115 is sent to a chiller 120. The chilled synthesis gas stream 125, which has a temperature of about 0° C. to about 40° C., is sent to a knockout pot 130 where a water stream 135 is removed resulting in a second chilled synthesis gas stream 140 having a lower level of water than the incoming chilled synthesis gas stream 125. In cases where methanol is present in the shifted synthesis gas stream 115, a portion of the methanol will be removed with water stream 135.

The second chilled synthesis gas stream 140 is sent to the hydrogen PSA unit 145 where it is separated into a first high-pressure hydrogen product stream 150, a low-pressure hydrogen-depleted tail gas stream 155, and optionally a fuel gas stream 160.

The first high-pressure hydrogen product stream 150 may have a temperature of 15 to 50° C. and a pressure of 2000 to 4000 kPa(g), and it may contain 99.0 to 99.999 mol % hydrogen, less than 1 ppmv carbon dioxide, less than 1 ppmv to 1000 ppmv methane, less than 1 ppmv to 50 ppmv carbon monoxide, 0 to 2000 ppmv nitrogen, less than 1 ppmv water, 0 to 3000 ppmv argon, and less than 0.1 ppmv methanol.

The low-pressure hydrogen-depleted tail gas stream 155 may have a temperature of 10 to 40° C. and a pressure of 20 to 50 kPa(g), and it may contain 20 to 30 mol % hydrogen, 50 to 80 mol % carbon dioxide, 2 to 15 mol % methane, 1 to 15 mol % carbon monoxide, 0 to 2 mol % nitrogen, 1 to 2 mol % water, 0 to 0.4 mol % argon, and 0 to 1000 ppmv methanol.

The low-pressure hydrogen-depleted tail gas stream 155 is compressed in tail gas compressor 165 from a pressure in the range of about 110 kPa to about 200 kPa to a pressure in the range of about 3,000 kPa to about 6,000 kPa.

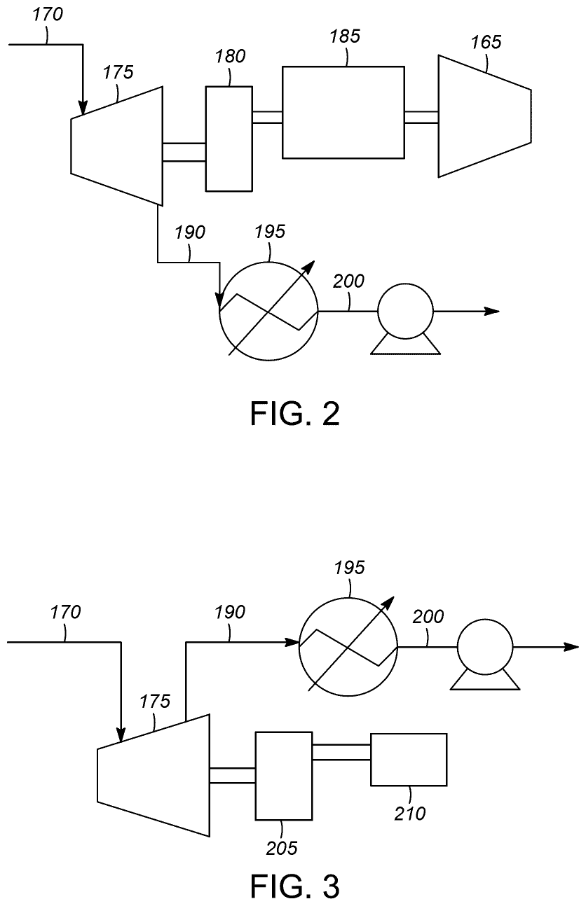

The low-pressure steam stream 170 from the hydrogen production process unit 110 is used to generate power to operate the tail gas compressor 165, using the steam turbine as shown in FIGS. 2-3, for example.

FIGS. 2-3 illustrate different arrangements for the steam turbine operation. In FIG. 2, the low-pressure steam stream 170 (one or more) is sent to the steam turbine 175. The steam turbine 175 is connected to a speed changing gear box 180 which is connected to the motor 185 for the tail gas compressor 165. If a different type of centrifugal compressor is used, the steam turbine could be connected to the compressor. The power generated by the steam turbine 175 is used to reduce the amount of imported power required to operate the tail gas compressor 165. The steam exhaust stream 190 from the steam turbine 175 is sent to a condenser 195 forming condensate 200. Suitable condensers include, but are not limited to, water cooled steam surface condensers, air cooled steam surface condensers, wetted surface air condensers, or combinations thereof. The condensate 200 could be recycled or reused in the hydrogen production process, for feed water to produce steam, for example, or it could be an effluent from the process.

In FIG. 3, the low-pressure steam stream 170 is sent to the steam turbine 175 which is connected to a speed changing gear box 205, and a generator 210 which generates power which can be used to reduce the overall need for imported power for the tail gas compressor 165 or other power needs. The steam exhaust stream 190 from the steam turbine 175 is sent to a condenser 195 forming condensate 200.

Returning to FIG. 1, the compressed tail gas stream 210 is dried in drier 215, and the compressed, dried tail gas stream 220 is sent to a sent to a CO₂ recovery unit 225 where it is separated into the carbon dioxide-enriched product stream 230 and an overhead stream 235. The carbon dioxide-enriched product stream 230 is recovered.

The overhead stream 235 may have a temperature of 20 to 30° C. and a pressure of 3000 to 4500 kPa(g), and it may contain 50 to 80 mol % hydrogen, 10 to 20 mol % carbon dioxide, 5 to 15 mol % methane, 3 to 12 mol % carbon monoxide, 0 to 10 mol % nitrogen, and 0 to 1 mol % argon.

The overhead stream 235 is sent to an overhead PSA unit 240 to form a low-pressure carbon dioxide stream 245 enriched in carbon dioxide and an off-gas stream 250 enriched in hydrogen and at least one of carbon monoxide, methane, nitrogen, and argon.

The low-pressure carbon dioxide stream 245 may have a temperature of 10 to 20° C. and a pressure of 30 to 50 kPa(g), and it may contain 10 to 20 mol % hydrogen, 60 to 80 mol % carbon dioxide, 2 to 10 mol % methane, 2 to 10 mol % carbon monoxide, 0 to 10 mol % nitrogen, and 0 to 0.5 mol % argon.

The off-gas stream 250 may have a temperature of 30 to 40° C. and a pressure of 3000 to 4500 kPa(g), and it may contain 50 to 90 mol % hydrogen, 0.01 to 0.5 mol % carbon dioxide, 5 to 30 mol % methane, 5 to 30 mol % carbon monoxide, 0 to 20 mol % nitrogen, and 0 to 1 mol % argon.

In some embodiments, the low-pressure carbon dioxide stream 245 is combined with the low-pressure hydrogen-depleted tail gas stream 155 and recycled to the CO₂ recovery unit 225.

In some embodiments the off-gas stream 250 can be send to an overhead hydrogen PSA unit 255 where it is separated into a second high-pressure hydrogen product stream 260 and a second tail gas stream 265.

The second high-pressure hydrogen product stream 260 can be combined with the first high-pressure hydrogen product stream 150 and recovered.

The second tail gas stream 265 can be compressed in second tail gas compressor 270, and the compressed second tail gas stream 275 can be recycled to the hydrogen production process unit 110.

### EXAMPLE

A saturated low pressure steam stream (159° C./590 kPa (a)) is superheated to 198.7° C. (70° C. superheat) prior to being let down in a low pressure condensing turbine to 12.5 kPa (a) (0.125 bar (a)). The exhaust is completely condensed using a water-cooled steam surface condenser and then returned to the steam system (deaerator) using a steam surface condenser condensate pump.

With about 80 metric ton/hr superheated low pressure steam (70° C. superheat), the estimated shaft work generated is about 10.3 MW with 75% steam turbine efficiency.

### Specific Embodiments

While the following is described in conjunction with specific embodiments, it will be understood that this description is intended to illustrate and not limit the scope of the preceding description and the appended claims.

A first embodiment of the invention is a method of producing a hydrogen-enriched product and recovering CO₂ comprising providing a synthesis gas stream comprising hydrogen and carbon dioxide from a hydrogen production process, the hydrogen production process producing low-grade heat; producing a low-pressure steam stream from the low-grade heat; separating the synthesis gas stream in a hydrogen pressure swing adsorption (PSA) unit into a first high-pressure hydrogen stream enriched in hydrogen and a hydrogen depleted tail gas stream comprising a portion of the hydrogen and the carbon dioxide; compressing the hydrogen depleted tail gas stream in a tail gas compressor to form a compressed tail gas stream, or compressing a refrigerant gas stream in a refrigerant gas compressor in a cryogenic fractionation CO₂ process, or both; introducing the low-pressure steam stream to a turbine to generate power for the tail gas compressor or the refrigerant gas compressor; separating the compressed tail gas stream in a CO₂ recovery system into a CO₂-enriched product stream and an overhead stream comprising the portion of the hydrogen; and recovering the CO₂-enriched product stream. An embodiment of the invention is one, any or all of prior embodiments in this paragraph up through the first embodiment in this paragraph wherein the low-pressure steam stream comprises a first low-pressure steam stream having a first temperature and a first pressure, and a second low-pressure steam stream having a second temperature and a second pressure, the first temperature being different from the second temperature, or the first pressure being different from the second pressure, or both. An embodiment of the invention is one, any or all of prior embodiments in this paragraph up through the first embodiment in this paragraph wherein the turbine is a steam turbine. An embodiment of the invention is one, any or all of prior embodiments in this paragraph up through the first embodiment in this paragraph wherein the steam turbine is a condensing-induction steam turbine. An embodiment of the invention is one, any or all of prior embodiments in this paragraph up through the first embodiment in this paragraph wherein the low-pressure steam stream is superheated. An embodiment of the invention is one, any or all of prior embodiments in this paragraph up through the first embodiment in this paragraph wherein the hydrogen production process comprises a steam reforming unit with an optional gas heated reformer, an autothermal reforming unit with an optional gas heated reformer, a partial oxidation unit, or a gasification unit. An embodiment of the invention is one, any or all of prior embodiments in this paragraph up through the first embodiment in this paragraph further comprising separating the overhead stream from the CO₂ recovery system into at least a second high-pressure hydrogen stream enriched in hydrogen, and a low-pressure CO₂ stream enriched in carbon dioxide. An embodiment of the invention is one, any or all of prior embodiments in this paragraph up through the first embodiment in this paragraph further comprising recycling the low-pressure CO₂ stream to the tail gas compressor. An embodiment of the invention is one, any or all of prior embodiments in this paragraph up through the first embodiment in this paragraph wherein the turbine is connected to a generator. An embodiment of the invention is one, any or all of prior embodiments in this paragraph up through the first embodiment in this paragraph wherein the turbine is directly connected to the tail gas compressor or the refrigerant gas compressor with a speed-changing gear box and a motor. An embodiment of the invention is one, any or all of prior embodiments in this paragraph up through the first embodiment in this paragraph wherein the total amount of power required to operate the tail gas compressor or the refrigerant gas compressor is reduced by 20% or more. An embodiment of the invention is one, any or all of prior embodiments in this paragraph up through the first embodiment in this paragraph further comprising generating additional low-pressure steam or increasing a temperature of the low-pressure steam stream, or increasing a pressure of the low-pressure steam stream, or combinations thereof by contacting the low-grade heat or the low-pressure steam stream with a phosphoric acid stream comprising phosphoric acid to oligomerize the phosphoric acid forming a diphosphoric acid stream comprising diphosphoric acid and water; condensing the water; increasing a pressure of the diphosphoric acid stream; evaporating the water with the low-grade heat or the low-pressure steam stream, the diphosphoric acid absorbing the evaporated water forming the phosphoric acid stream by de-oligomerization and hydrolysis of the diphosphoric acid and increasing a heat value of the low-grade heat or the low-pressure steam stream; and decreasing a pressure of the phosphoric acid stream.

A second embodiment of the invention is a method of producing a hydrogen-enriched product and recovering CO₂ comprising providing a synthesis gas stream comprising hydrogen and carbon dioxide from a hydrogen production process, the hydrogen production process producing low-grade heat; producing a low-pressure steam stream from the low-grade heat; separating the synthesis gas stream in a hydrogen pressure swing adsorption (PSA) unit into a first high-pressure hydrogen stream enriched in hydrogen and a hydrogen depleted tail gas stream comprising a portion of the hydrogen and the carbon dioxide; compressing the hydrogen depleted tail gas stream in a tail gas compressor to form a compressed tail gas stream, the tail gas compressor requiring a total amount of power to operate, or compressing a refrigerant gas stream in a refrigerant gas compressor in a cryogenic fractionation CO₂ process, the refrigerant gas compressor requiring a total amount of power to operate, or both; superheating the low-pressure steam stream; introducing the superheated low-pressure steam stream to a turbine to generate power, the total amount of power to operate the tail gas compressor, or the refrigerant gas compressor, or both being reduced by 20% or more using the power produced by the turbine; separating the compressed tail gas stream in a CO₂ recovery system into a CO₂-enriched product stream and an overhead stream comprising the portion of the hydrogen; and recovering the CO₂-enriched product stream. An embodiment of the invention is one, any or all of prior embodiments in this paragraph up through the second embodiment in this paragraph wherein the low-pressure steam stream comprises a first low-pressure steam stream having a first temperature and a first pressure, and a second low-pressure steam stream having a second temperature and a second pressure, the first temperature being different from the second temperature, or the first pressure being different from the second pressure, or both. An embodiment of the invention is one, any or all of prior embodiments in this paragraph up through the second embodiment in this paragraph wherein the turbine is a steam turbine. An embodiment of the invention is one, any or all of prior embodiments in this paragraph up through the second embodiment in this paragraph wherein the hydrogen production process comprises a steam reforming unit with an optional gas heated reformer, an autothermal reforming unit with an optional gas heated reformer, a partial oxidation unit, or a gasification unit. An embodiment of the invention is one, any or all of prior embodiments in this paragraph up through the second embodiment in this paragraph further comprising separating the overhead stream from the CO₂ recovery system into at least a second high-pressure hydrogen stream enriched in hydrogen, and a low-pressure CO₂ stream enriched in carbon dioxide; and recycling the low-pressure CO₂ stream to the tail gas compressor. An embodiment of the invention is one, any or all of prior embodiments in this paragraph up through the second embodiment in this paragraph wherein the turbine is connected to a generator. An embodiment of the invention is one, any or all of prior embodiments in this paragraph up through the second embodiment in this paragraph further comprising generating additional low pressure steam, or increasing a temperature of the low-pressure steam stream, or increasing a pressure of the low-pressure steam stream, or combinations thereof by contacting the low-grade heat or the low pressure steam stream with a phosphoric acid stream comprising phosphoric acid to oligomerize the phosphoric acid forming a diphosphoric acid stream comprising diphosphoric acid and water; condensing the water; increasing a pressure of the diphosphoric acid stream; evaporating the water with the low-grade heat or the low pressure steam stream, the diphosphoric acid absorbing the evaporated water forming the phosphoric acid stream by de-oligomerization and hydrolysis of the diphosphoric acid and increasing a heat value of the low-grade heat or the low pressure steam stream; and decreasing a pressure of the phosphoric acid stream.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A method of producing a hydrogen-enriched product and recovering CO₂ comprising:
providing a synthesis gas stream comprising hydrogen and carbon dioxide from a hydrogen production process, the hydrogen production process producing low-grade heat;
producing a low-pressure steam stream from the low-grade heat;
separating the synthesis gas stream in a hydrogen pressure swing adsorption (PSA) unit into a first high-pressure hydrogen stream enriched in hydrogen and a hydrogen depleted tail gas stream comprising a portion of the hydrogen and the carbon dioxide;
compressing the hydrogen depleted tail gas stream in a tail gas compressor to form a compressed tail gas stream, or compressing a refrigerant gas stream in a refrigerant gas compressor in a cryogenic fractionation CO₂ process, or both;
introducing the low-pressure steam stream to a turbine to generate power for the tail gas compressor or the refrigerant gas compressor;
separating the compressed tail gas stream in a CO₂ recovery system into a CO₂-enriched product stream and an overhead stream comprising the portion of the hydrogen; and
recovering the CO₂-enriched product stream.

2. The method of claim 1 wherein the low-pressure steam stream, or streams (more than one) comprises a first low-pressure steam stream having a first temperature and a first pressure, and a second low-pressure steam stream having a second temperature and a second pressure, the first temperature being different from the second temperature, or the first pressure being different from the second pressure, or both.

3. The method of claim 1 wherein the turbine is a steam turbine.

4. The method of claim 3 wherein the steam turbine is a condensing-induction steam turbine.

5. The method of claim 1 wherein the low-pressure steam stream is not superheated and further comprising superheating the low-pressure steam stream.

6. The method of claim 1 wherein the hydrogen production process comprises a steam reforming unit with an optional gas heated reformer, an autothermal reforming unit with an optional gas heated reformer, a partial oxidation unit, or a gasification unit.

7. The method of claim 1 further comprising:
separating the overhead stream from the CO₂ recovery system into at least a second high-pressure hydrogen stream enriched in hydrogen, and a low-pressure CO₂ stream enriched in carbon dioxide.

8. The method of claim 7 further comprising:
recycling the low-pressure CO₂ stream to the tail gas compressor.

9. The method of claim 1 wherein the turbine is connected to a generator through a speed reducing gear box.

10. The method of claim 1 wherein the turbine is directly connected to the tail gas compressor or the refrigerant gas compressor with a speed-changing gear box and a motor.

11. The method of claim 1 wherein the total amount of power required to operate the tail gas compressor or the refrigerant gas compressor is reduced by 20% or more.

12. The method of claim 1 further comprising:
generating additional low-pressure steam or increasing a temperature of the low-pressure steam stream, or increasing a pressure of the low-pressure steam stream, or combinations thereof by:
contacting the low-grade heat or the low-pressure steam stream with a phosphoric acid stream comprising phosphoric acid to oligomerize the phosphoric acid forming a diphosphoric acid stream comprising diphosphoric acid and water;
condensing the water;
increasing a pressure of the diphosphoric acid stream;
evaporating the water with the low-grade heat or the low-pressure steam stream, the diphosphoric acid absorbing the evaporated water forming the phosphoric acid stream by de-oligomerization and hydrolysis of the diphosphoric acid and increasing a heat value of the low-grade heat or the low-pressure steam stream; and
decreasing a pressure of the phosphoric acid stream.

13. A method of producing a hydrogen-enriched product and recovering CO₂ comprising:
providing a synthesis gas stream comprising hydrogen and carbon dioxide from a hydrogen production process, the hydrogen production process producing low-grade heat;
producing a low-pressure steam stream from the low-grade heat;
separating the synthesis gas stream in a hydrogen pressure swing adsorption (PSA) unit into a first high-pressure hydrogen stream enriched in hydrogen and a hydrogen depleted tail gas stream comprising a portion of the hydrogen and the carbon dioxide;
compressing the hydrogen depleted tail gas stream in a tail gas compressor to form a compressed tail gas stream, the tail gas compressor requiring a total amount of power to operate, or compressing a refrigerant gas stream in a refrigerant gas compressor in a cryogenic fractionation CO₂ process, the refrigerant gas compressor requiring a total amount of power to operate, or both;
superheating the low-pressure steam stream;
introducing the superheated low-pressure steam stream to a turbine to generate power, the total amount of power to operate the tail gas compressor, or the refrigerant gas compressor, or both being reduced by 20% or more using the power produced by the turbine;
separating the compressed tail gas stream in a CO₂ recovery system into a CO₂-enriched product stream and an overhead stream comprising the portion of the hydrogen; and
recovering the CO₂-enriched product stream.

14. The method of claim 13 wherein the low-pressure steam stream(s) comprises a first low-pressure steam stream having a first temperature and a first pressure, and a second low-pressure steam stream having a second temperature and a second pressure, the first temperature being different from the second temperature, or the first pressure being different from the second pressure, or both.

15. The method of claim 13 wherein the turbine is a steam turbine.

16. The method of claim 13 wherein the hydrogen production process comprises a steam reforming unit with an optional gas heated reformer, an autothermal reforming unit with an optional gas heated reformer, a partial oxidation unit, or a gasification unit.

17. The method of claim 13 further comprising:
separating the overhead stream from the CO₂ recovery system into at least a second high-pressure hydrogen stream enriched in hydrogen, and a low-pressure CO₂ stream enriched in carbon dioxide; and
recycling the low-pressure CO₂ stream to the tail gas compressor.

18. The method of claim 13 wherein the turbine is connected to a generator.

19. The method of claim 13 further comprising:
generating additional low pressure steam, or increasing a temperature of the low-pressure steam stream, or increasing a pressure of the low-pressure steam stream, or combinations thereof by:
contacting the low-grade heat or the low pressure steam stream with a phosphoric acid stream comprising phosphoric acid to oligomerize the phosphoric acid forming a diphosphoric acid stream comprising diphosphoric acid and water;
condensing the water;
increasing a pressure of the diphosphoric acid stream;
evaporating the water with the low-grade heat or the low pressure steam stream, the diphosphoric acid absorbing the evaporated water forming the phosphoric acid stream by de-oligomerization and hydrolysis of the diphosphoric acid and increasing a heat value of the low-grade heat or the low pressure steam stream; and
decreasing a pressure of the phosphoric acid stream.
